(19) United States
(12) Patent Application Publication
(10) Pub. No.: US 2008/0007401 A1
(43) Pub. Date: Jan. 10, 2008

(54) Climate control monitoring system

(76) Inventor: Dominic Pizzo, Shelby Township, MI (US)

Correspondence Address: WARN, HOFFMANN, MILLER & LALONE, .P.C, PO BOX 70098, ROCHESTER HILLS, MI, 48307, US

(21) Appl. No.: 11/820,782

(22) Filed: Jun. 20, 2007

Related U.S. Application Data
(60) Provisional application No. 60/815,093, filed on Jun. 20, 2006.

(51) Int. Cl. G08B 21/00

(52) U.S. Cl. 340/540; 700/276

(57) ABSTRACT

A method or system for monitoring energy consumption in structures during construction. The system includes one or more sensor devices having a transmitter, repeater and energy consumption service. The one or more sensor devices sense one or more characteristics associated with energy. The sensors transmit a first data signal that contains information related to the characteristics under measurement. The repeater receives the first data signal and then transmits a second data signal based on the value of the first data signal to an energy consumption service. The second data signal is analyzed and a determination is made whether or not the characteristics being sensed by the sensor exceeds a predetermined value. If the predetermined value is exceeded an alert signal is generated to notify a user that the one or more characteristics are exceeding a predetermined range.

### CROSS-REFERENCE TO RELATED APPLICATIONS

This application claims the benefit of U.S. Provisional Application No. 60/815,093, filed Jun. 20, 2006.

### FIELD OF THE INVENTION

The present invention relates to a method and system for monitoring energy consumption in structures during construction.

### BACKGROUND OF THE INVENTION

Rising energy costs have affected owners and builders of commercial and residential buildings. Gas, electricity, and in some areas water, has increased substantially over the course of a few years. Despite energy costs, there has been an increase in the construction of both new buildings as well as remodeling existing buildings. This construction goes on year round despite weather conditions.

One of the problems subcontractors and general contractors face is trying to make sure the building that is being worked on is at an appropriate temperature. Controlling the temperature is important for the comfort of the worker. Also controlling the temperature of the building will ensure that the building materials will be properly installed. For example, drywall putty needs to be fully dried before applying paint. Also trim moulding can gap if it is installed at a warmer temperature and then the building is cooled off significantly. General contractors oftentimes are paying the energy costs during the construction phase and it is desirable to minimize wasted energy. If workers open a window on a winter day because it is too hot inside the building, energy is literally being thrown out the window. Furthermore workers sometimes forget to shut windows once they are done working in a building which creates further wasted energy.

The same principle with regard to heat in the winter months applies to electricity in the summer months. During construction air conditioners are run in the summer to remove the humidity during the construction process. However despite the fact that the air conditioning is running windows are sometimes left open once the work day is over. Water consumption can also be a problem where workers will inadvertently leave water running or if pipes in a building burst. Also, the time it takes to construct a building can be affected by factors such as humidity. Controlling humidity is desirable to ensure paint and other materials will dry properly. Thus there is a need to monitor resource consumption during the construction process.

With regard to monitoring temperature in a building, in the early stages of construction formal thermostats have not been installed. Temporary thermostats are used, however, these types of thermostats maintain the building a small range of temperature. This does not provide the general contractor with a way of monitoring the temperature very easily without going to each individual building or unit. Furthermore the general contractor has no way of knowing if a door or window has been left open.

The present invention focuses on providing a system and method of remotely monitoring the resource consumption in a building. It can be used to monitor all types of resource usage of a building whether it is under construction or simply part of a group of buildings where energy consumption monitoring is desired.

### SUMMARY OF THE INVENTION

The present invention is directed to a method or system for monitoring energy consumption in structures during construction. The system includes one or more sensor devices having a transmitter, repeater and energy consumption service. The one or more sensor devices sense one or more characteristics associated with energy. The sensors transmit a first data signal that contains information related to the characteristics under measurement. The repeater receives the first data signal and then transmits a second data signal based on the value of the first data signal to an energy consumption service. The second data signal is analyzed and a determination is made whether or not the characteristics being sensed by the sensor exceeds a predetermined value. If the predetermined value is exceeded an alert signal is generated to notify a user that the one or more characteristics are exceeding a predetermined range.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of the method and system of one embodiment of the present invention; and

FIG. 2 is a schematic view of an alternate embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

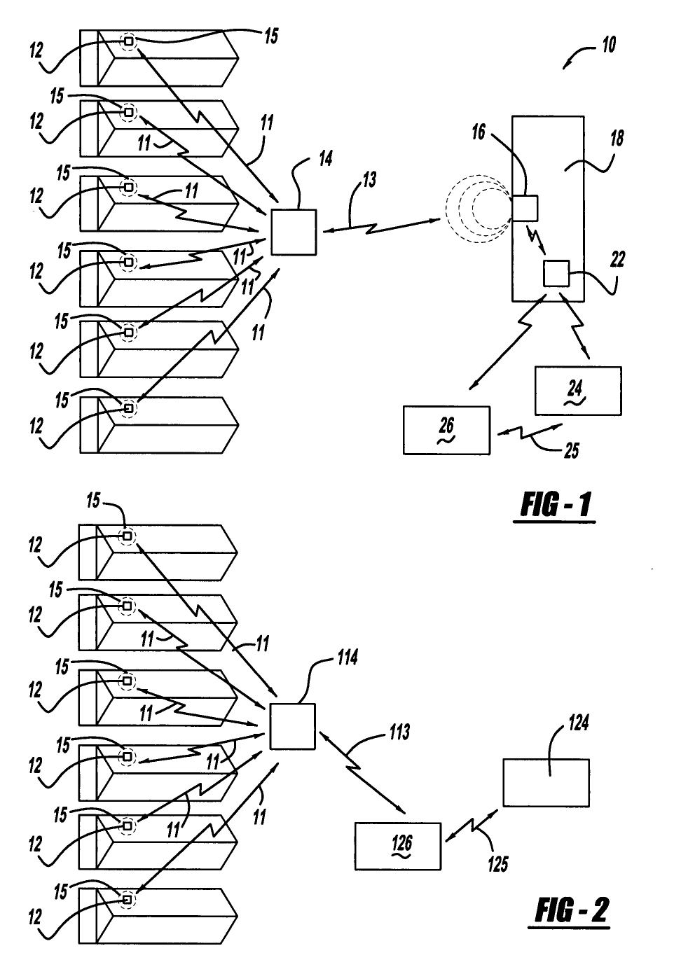

Referring now to FIG. 1, a system 10 uses one or more sensors 12 that are operably located to each of the units of a building 15 being monitored. FIG. 1 depicts a multi-unit dwelling; however, separate structures or buildings can be monitored. While this embodiment will discuss using this system in a setting where buildings are under construction, it is possible for the system 10 to be used in already constructed buildings, apartments and commercial structures. The sensors 12 can be simply temperature devices placed within the unit or they can be operably connected to a device 13 such as a power meter, water meter, gas meter, furnace, air conditioning system, humidistat or other device that monitoring is desired. The sensors 12 relay a first data signal 11 that is indicative a one or more characteristics being monitored. The characteristics can vary and can include temperature, humidity, water consumption, electricity, gas consumption and combinations thereof. The sensors 12 have a transmitter that transmits the first data signal 11 to a repeater 14. The repeater 14 receives the first data signal 11 and transmits a second data signal 13 that is indicative of the first data signal 11 value. The second data signal 13 can have the same value as the first data signal 11 or it can be converted to a different type of signal that will be interpreted in later steps. In any event the first data signal 11 and second data signal 13 are indicative of the characteristic measured by the sensors 12. The first and second signals 11, 13 can be sent by hardwires or using wireless technology.

The second data signal 13 transmitted from the repeater 14 is sent to a receiver 16 in the construction trailer 18, management office or other designated location. The receiver 16 translates 20 the data from the second signal 13 using software into a readable format on a computer 22 located in the construction trailer 18 or office or at some other location. The computer 22 can use the internet or some other suitable connection for sending the data to a user 24 or the energy consumption service 26 or both locations. The energy consumption service 26 includes a computer that has software that can determine if the characteristics measured by the sensors 12 exceed a predetermined value. If a predetermined value is exceeded the computer can automatically send an alert signal 25 notifying users of the system 10 that there is a problem. The predetermined value analyzed by the energy consumption service 26 can be programmed by users of the system and can be reset as desired. For example if temperature is being monitored, the alert signal 25 will be sent if a sensor 12 exceeds a certain temperature range. If electricity, water or gas are being monitored, an alter signal 25 will be generated if these resources are being used excessively. Additionally signals can be generated if resources are being used outside of certain normal working hours. This would prevent damage to buildings in situations where water lines break or where gas leaks are occurring.

The present invention does not necessarily use a repeater or receiver. The temperature transmitters can send data directly to a computer equipped with a receiver. FIG. 2 depicts an alternate configuration of an energy consumption monitoring system 100. The system 100 has multiple sensors 112 that transmit a first signal 111 to a repeater 114. The repeater 114 transmits a second signal 1 13 directly to an energy consumption service 126 which monitors and sends an alert signal 125 to a user 124. This embodiment eliminates the need to have a receiver 16 and additional computer 22. The repeater 114 in this embodiment can communicate with the energy consumption service 126 either using wireless technology or through hardwire. It is within the scope of this invention for some applications to not require the use of a repeater 114 and instead the sensors 112 can transmit the first signal 111 directly to the energy consumption monitoring service 126.

The description of the invention is merely exemplary in nature and, thus, variations that do not depart from the gist of the invention are intended to be within the scope of the invention. Such variations are not to be regarded as a departure from the spirit and scope of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of monitoring energy consumption and structures during construction comprising the steps of:
providing one or more sensor devices having a transmitter;
providing a repeater;
providing an energy consumption monitoring service;
operating said one or more sensor devices to sense one or more characteristics associated with energy;
transmitting a first data signal from said transmitter of said one or more sensor devices to said repeater, wherein said first data signal contains information related to said one or more characteristics;
receiving said first data signal by a repeater;
communicating a second data signal to said energy consumption monitoring service; and
receiving and analyzing said data signal by said energy consumption service.

2. The method of claim 1 further comprising the steps of:
using said energy consumption service to determine whether said second data signal exceeds a predetermined value; and
transmitting an alert signal from said energy consumption service to a user.

3. The method of claim 2, wherein said energy consumption service includes a computer that automatically carries out the steps of receiving and analyzing, determining, and transmitting.

4. The method of claim 1, wherein said energy consumption service includes a computer that automatically carries out the steps of receiving and analyzing.

5. The method of claim 1, wherein said one or more characteristics associated with energy are one selected from the group comprising temperature, humidity, water consumption, electricity, gas consumption, and combinations thereof.

6. The method of claim 1, wherein said one or more sensor devices are one selected from the group comprising a temperature sensor, an electrical sensor operably connected to a power meter, a sensor operably connected to a furnace or air conditioner, a sensor operably connected to a gas meter, a sensor operably connected to a water meter, or combinations thereof.

7. The method of claim 1, wherein said steps of transmitting and communicating are carried out using wireless signals, hard wires, or combinations thereof.

8. A system for monitoring energy consumption and structures during construction comprising:
one or more sensor devices having a transmitter;
a repeater;
an energy consumption monitoring service including a computer that automatically determines whether energy consumption is exceeding a predetermined value;
a signal generated by said one or more sensor devices that is indicative of one or more characteristics in a structure under construction;
a second signal generated by said repeater that is indicative of said first signal; and
an alert signal generated by said energy consumption monitoring service that notifies a user that energy consumption in said structure has exceeded a predetermined value.

9. The system of claim 8, wherein said one or more characteristics are one selected from a group comprising temperature, humidity, water consumption, electricity, gas consumption, and combinations thereof.

10. The system of claim 8, wherein said one or more sensor devices are ones selected from a group comprising a temperature sensor, an electrical sensor operably connected to a power meter, a sensor operably connected to a furnace or air conditioner, a sensor operably connected to a gas meter, a sensor operably connected to a water meter, or combinations thereof.

11. The system of claim 8, wherein said first data signal and said second data signal are wireless signals, are transmitted through hard wires, or combinations thereof.
